(19) United States
(12) Patent Application Publication
(10) Pub. No.: US 2013/0094571 A1
(43) Pub. Date: Apr. 18, 2013

(54) LOW LATENCY VIDEO COMPRESSION

(71) Applicants: Lei Zhang, Richmond Hill (CA); Ji Zhou, Shanghai (CN); Zhen Chen, Shanghai (CN); Mingqi Wu, Suzhou (CN)

(72) Inventors: Lei Zhang, Richmond Hill (CA); Ji Zhou, Shanghai (CN); Zhen Chen, Shanghai (CN); Mingqi Wu, Suzhou (CN)

(73) Assignees: ATI TECHNOLOGIES ULC, Markham (CA); ADVANCED MICRO DEVICES, INC., Sunnyvale, CA (US)

(21) Appl. No.: 13/272,670

(22) Filed: Oct. 13, 2011

(51) Int. Cl. H04N 7/26

(52) U.S. Cl. 375/240.03; 375/E07.14; 375/E07.154

(57) ABSTRACT

A method and system are described for low-latency video. In the method a frame, selected from a group of frames, is divided into P-regions and an I-region based on an assigned refresh pattern in a refresh loop. An I-region bit budget and a P-region bit budget are determined. Quantization parameters are determined using the I-region bit budget and the P-region bit budget. Macroblocks of the selected frame are encoded based on the quantization parameters. The I-complexity and P-complexity are updated and a new frame bit budget is determined. The dividing, determining of the I-region bit budget, determining of the P-region bit budget, determining of quantization parameters and encoding are repeated for each remaining frame in the group of frames.

### BACKGROUND

Digital video systems, including wireless systems, are becoming increasingly common. In such systems each picture or frame of a moving image is encoded in a transmitter, transmitted to a receiver, decoded in the receiver, and displayed on a display device. In some such systems a user may perform some action at the transmitter and expect to see an essentially instant response on a display visible to that user or to another user at a different location. An example of this is a user moving a cursor on a hand-held device and expecting to see essentially instantaneous corresponding movement of a cursor on a display located in the same room with the user. Any observable delay, or latency, between the user's action and the response on the display is undesirable. Another example is a video conferencing system, where two users in different locations are exchanging images. Observable latency may occur when buffers cannot keep up with a large incoming bit rate or a bit rate that fluctuates over a large range from frame to frame. To reduce latency, bit rates must be carefully controlled and not allowed to fluctuate outside a restricted range.

The terms compression and quantization refer to reducing a number of bits needed to encode a frame without noticeable degradation of image quality.

### SUMMARY OF EMBODIMENTS

A method and system are described for low-latency video. In the method a frame, selected from a group of frames, is divided into P-regions and an I-region based on an assigned refresh pattern in a refresh loop. An I-region bit budget and a P-region bit budget are determined. Quantization parameters are determined using the I-region bit budget and the P-region bit budget. Macroblocks of the selected frame are encoded based on the quantization parameters. An I-complexity and P-complexity are updated and a new frame bit budget is determined. The dividing, determining of the I-region bit budget, determining of the P-region bit budget, determining of quantization parameters, and encoding are repeated for each remaining frame in the group of frames.

A video compression system configured to reduce latency and prevent buffer overflow includes an encoder configured to encode a received frame, a refresh system configured to provide a predetermined refresh pattern to the encoder, and a rate control system, configured to control an encoding rate of the encoder.

### BRIEF DESCRIPTION OF THE DRAWINGS

FIG. 1 shows an example of a low-latency video refresh loop and a refresh pattern.

FIG. 2 shows an embodiment of a method of reducing video latency.

FIG. 3 shows an embodiment of a video encoding system with reduced latency.

FIG. 4 shows an example of an embodiment of a video encoding system with reduced latency as part of a larger system.

### DETAILED DESCRIPTION OF THE PREFERRED EMBODIMENTS

To reduce latency, pixels of a given frame in a video transmission may be divided into regions of different designated types. Each region may be further divided into blocks of pixels called macroblocks. Regions of each type may be encoded in different ways, having different amounts of compression, or quantization. For example a region designated as an I-region (“intra” region) may be encoded as if it were a single still image. Encoding of an I-region uses only the bits contained in that region itself. All macroblocks in an I-region are encoded as I-macroblocks. By contrast, a region designated as a P-region (“progressive” region) may be encoded by making use of a region in a previous frame. A macroblock in a P-region may be encoded as either an I-macroblock or a P-macroblock. As an example, a current P-region may be compared with a previously processed region, either I or P, and only those pixels in the current region that have changed are encoded. The current region and the previously processed region may or may not have corresponding locations in a current frame and a previous frame, respectively. An example is provided by a video scene in which an object is moving in front of a stationary background. In a P-region, only those pixels representing the moving object may require encoding. It follows that an I-region will likely require more bits for encoding than does a P-region. It may be desirable, therefore, to reduce the number of I-regions as much as possible. On the other hand, at least one I-region may be necessary to maintain image quality and stop errors propagating from one frame to another. In particular, use of at least one I-region may be a necessity following a scene change, since the first frame of a new scene may have no pixels in common with the last frame of the previous scene. Scene changes are addressed further below.

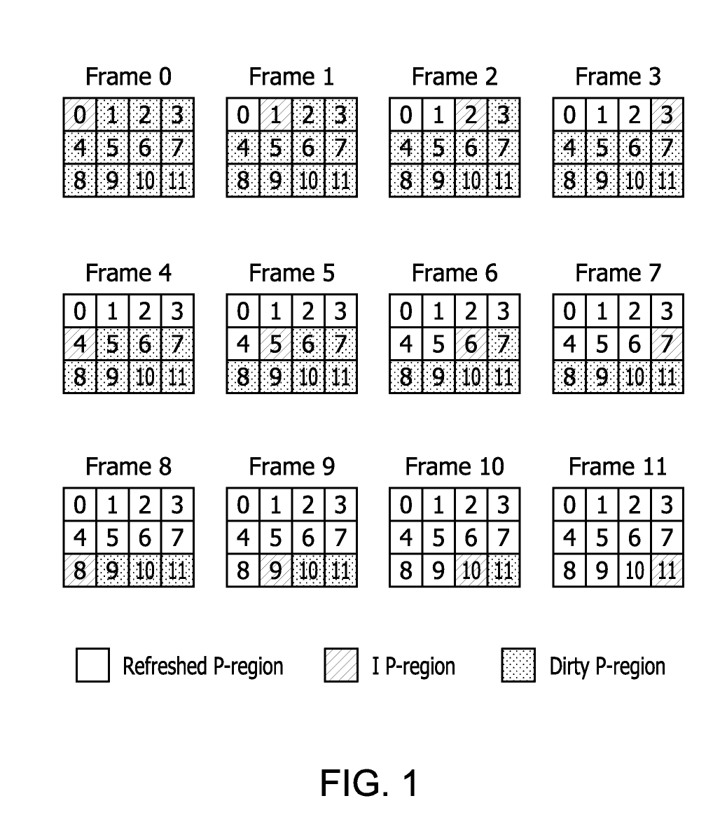

An example of part of a method for reducing latency is shown in FIG. 1. Twelve (12) consecutive frames are shown, labeled by an index j, running from 0 to 11. The twelve frames together make up a refresh loop. Each of the twelve frames is divided into 12 regions. The number of regions is equal to the number of frames in the refresh loop. The number 12, however, is arbitrary and not limiting. In each frame of the refresh loop, one of these regions is designated as an I-region and the remaining ones as P-regions, as described above. The region designated as the I-region (and therefore the position of the I-region within a frame) differs from frame to frame in the refresh loop. In a single refresh loop, each and every region is designated as the I-region, in a specific order. Such an order is referred to as a refresh pattern. The refresh loop repeats every N frames, where N is 12 in FIG. 1. In the non-limiting example shown in FIG. 1, in a first frame in the refresh loop, Frame 0, Region 0 is designated to be an I-region and regions 1-11, that is, all remaining regions, are “dirty” P-regions. A dirty P-region is a P-region that has not yet been encoded as an I-region in any previous frame in a refresh loop. Such a P-region, therefore, has not yet been “cleaned” or “refreshed” in the current refresh loop and may be suffering propagated errors caused by transmission problems. Continuing with this example of a refresh pattern, in the next frame, Frame 1, Region 1 is designated as an I-region. Region 0, having been “refreshed” by having been encoded as an I-region in frame 0, is now a refreshed, or “clean”, P-region. Regions 2-11, having not yet been encoded as an I-region in the refresh loop are still dirty P-regions. The refresh pattern continues as shown, such that finally, in Frame 11, region 11 is designated as an I-region. Once a region is refreshed it remains refreshed for the rest of the refresh loop. Therefore, once the refresh loop ends, all regions 0-11 are refreshed P-regions. The frame following frame 11 will be encoded as in Frame 0 and the refresh loop repeats. In a current frame of a refresh loop, a macroblock in a refreshed P-region may only refer to a macroblock in a refreshed P-region of a previous frame, while a macroblock in a dirty P-region of the current frame may refer to any macroblock of any previous frame.

The refresh pattern may be described as the pattern of movement of the I-region from frame to frame during the refresh loop. The particular movement of the I-region shown in FIG. 1 is an example and is not to be considered limiting. The I-region may move in any pattern as a refresh pattern, such as a zig-zag, along a diagonal, or along a more complex path.

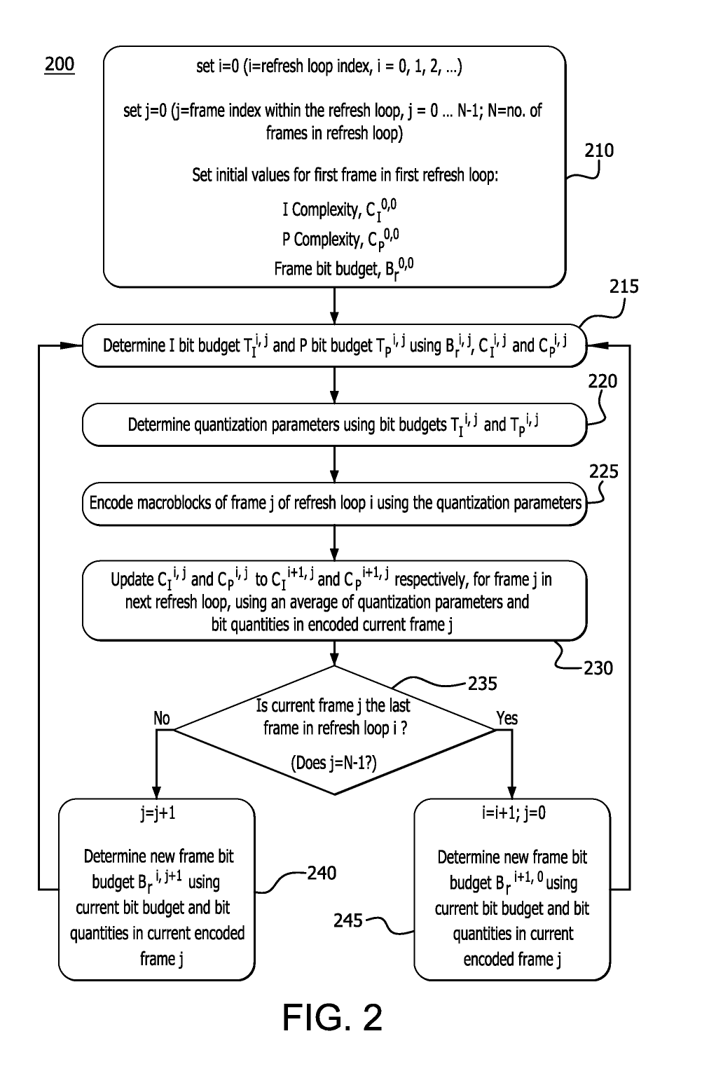

FIG. 2 shows an embodiment of a method 200 for reducing video latency and preventing buffer overflow in video encoding. The method may be implemented in combination with a refresh loop such as that shown in FIG. 1. In this description, a given refresh loop is designated by index i and a particular frame within a refresh loop is designated by index j. The number of frames in a refresh loop is denoted as N.

Referring to FIG. 2, initial values are set for an I-complexity C_{I}^{i,j}, a P-complexity C_{P}^{i,j}, and a frame bit budget Bᵣ^{i,j} 210. The initial values are to be applied to a first frame in a first group of frames, this first group of frames being the frames of a first refresh loop, and therefore i=0 and j=0 for setting the initial values. The complexities are each a measure of a tradeoff between bit rate used in transmitting an encoded frame and image distortion or loss of image quality in that frame. The frame bit budget is determined in part by a system bandwidth or a bit rate capacity. Complexities and frame bit budgets are described in greater detail below.

In an embodiment, an initial value of bit rate budget, Bᵣ^{0,0} may be set as

$${B}_{r}^{0 , 0} = BPP = \frac{{R}_{b}}{{R}_{f}} ,$$

where BPP is a number of bits per picture, or bits per frame, R_{b} denotes a nominal bit rate and R_{f} denotes a frame rate. As an example, initial values for the I-complexity and P-complexity for all N frames in the initial refresh loop may be set as:

$${C}_{I}^{0 , j} = \frac{70 {R}_{b}}{32} \\ and \\ {C}_{P}^{0 , j} = \frac{{R}_{b}}{2} ; \\ j = 0 … N \text{-} 1 \qquad Equation ( 1 )$$

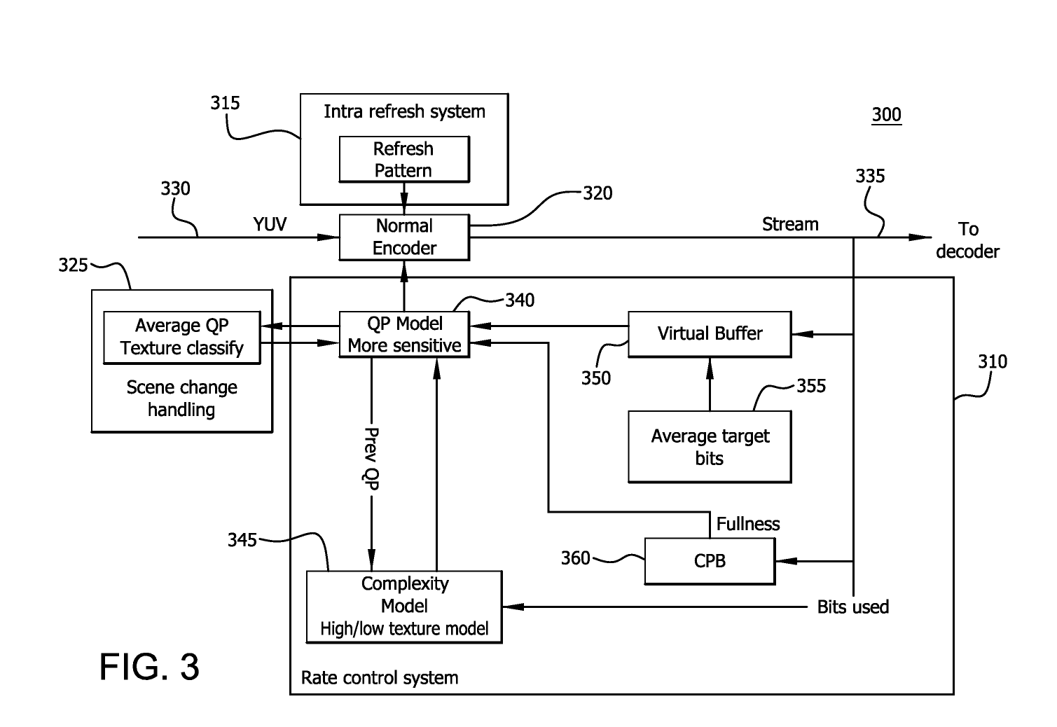

Once the initial values are set, the method operates in a cycle, running over consecutive frames. A refresh loop having a pre-defined refresh pattern is applied to a first group of N frames. The refresh pattern assigns a type—either I or P—to each region of each frame, in the manner of FIG. 1. Each selected frame is thus divided into P-regions and one I-region. A quantization of each macroblock in each region is carried out using quantization parameters that may depend on, among other factors, the fullness of a CPB buffer included in the rate control system, such as one described below with reference to FIG. 3. Values of quantization parameters may also depend on averages of quantization parameters used in previous frames, as described below. The CPB buffer stores at least a part of each frame before the frame is transmitted. If the buffer gets full and overflows, data loss and/or observable latency may result. In an embodiment, therefore, the amount of quantization may depend on how close the buffer is to being full. Each macroblock, in both I- and P-regions, may have a different quantization parameter.

Referring once again to FIG. 2, an I-region bit budget and a P-region bit budget are determined 215, as described below. Quantization parameters for the macroblocks of the P-regions and an I-region of the selected frame j in refresh loop i are determined based on the I-region bit budget and the P-region bit budget 220. Macroblocks of the selected frame are encoded based on the quantization parameters 225. After various quantities are updated 230, as described below, the cycle is repeated for each remaining frame in the first group of frames, as indicated by the “NO” path from 235 of FIG. 2. Once all N frames in the first group are encoded, the application of the refresh loop to a new group of N frames following the first group is begun, as indicated by the “YES” path from 235 of FIG. 2.

In an embodiment shown in FIG. 2, determination of quantization parameters proceeds at 215 and 220. An I-region bit budget T_{I}^{i,j} is determined using current values of the I-complexity C_{I}^{i,j}, of the P-complexity C_{P}^{i,j} and of the frame bit budget Bᵣ^{i,j}. I-region bit budget T_{I}^{i,j} may be determined using Equation 2:

$${T}_{I}^{i , j} = \frac{{B}_{r}^{i , j}}{1 + \frac{1}{K} \frac{{C}_{P}^{i , j}}{{C}_{I}^{i , j}}} . \qquad Equation ( 2 )$$

In Equation 2, K is a balancing constant, defined in order to constrain the relative values of the I-region quantization parameters and the P-region quantization parameters as a further guard against excessive latency and buffer overflow. For example, the quantization parameters may be constrained according to Equation 3:

$$\frac{1}{{Q}_{I}^{i , j}} = \frac{K}{{Q}_{P}^{i , j}} , \qquad Equation ( 3 )$$

where Q_{I}^{i,j} and Q_{P}^{i,j} are averages of quantization parameters over macroblocks of I-regions and P-regions, respectively, and K may be between 1.0 and 2.0, inclusive.

Corresponding to I-region bit budget T_{I}^{i,j}, a P-region bit budget T_{P}^{i,j} may be determined 215. In an embodiment, T_{P}^{i,j} may determined by subtracting I-region bit budget from frame bit budget, as in Equation 4:

T_{P}^{i,j}=Bᵣ^{i,j}−T_{I}^{i,j}. Equation (4)

Once bit budgets T_{I}^{i,j} and T_{P}^{i,j} have been determined, they may be used to determine current quantization parameters 220. These current quantization parameters may then be used to encode the current frame 225, as described above.

Once the current frame is encoded, the complexities C_{I}^{i,j} and C_{P}^{i,j} may be updated for use in determining bit budgets for a corresponding frame j in the next refresh loop 230. According to the index definitions above, these complexities are denoted as C_{I}^{i+1,j} and C_{P}^{i+1,j}. These updated complexities may be determined as follows. Let Q_{a,I}^{i,j} and Q_{a,P}^{i,j} be determined averages of quantization parameters over all macroblocks in the I- and P-regions, respectively, of the current frame j. These averages may be weighted averages. Let B_{u,I}^{i,j} and B_{u,P}^{i,j} be bit quantities generated by encoding of the I- and P-regions, respectively. Determine the quantities Ĉ_{I}^{i,j} and Ĉ_{P}^{i,j} using Equations 5 and 6, respectively.

Ĉ_{I}^{i,j}=Q_{a,I}^{i,j}B_{u,I}^{i,j} Equation (5)

Ĉ_{P}^{i,j}=Q_{a,P}^{i,j}B_{u,P}^{i,j} Equation (6)

Finally, determine updated I- and P-complexities using Equations 7 and 8, respectively.

$$\begin{matrix}{C}_{I}^{i + 1 , j} = \frac{{\hat{3 C}}_{I}^{i , j} + {C}_{I}^{i , j}}{4} & Equation ( 7 ) \\ {C}_{P}^{i + 1 , j} = \frac{{\hat{3 C}}_{P}^{i , j} + {C}_{P}^{i , j}}{4} . & Equation ( 8 )\end{matrix}$$

Once the current frame is encoded, a new frame bit budget is determined 240, 245 in a manner depending on whether or not the current frame is the last frame in the current refresh loop 235. If the current frame j is the last frame in current refresh loop i 235, then a new frame bit budget for a first frame in a new refresh loop may be determined 245 using Equation 9:

Bᵣⁱ⁺1,0=BPP+max(LIMIT_VALUE,Bᵣ^{i,N-1}−B_{u,I}^{i,N-1}−B_{u,P}^{i,N-1}). Equation (9)

If the current frame j is not the last frame in current refresh loop i 235, then a new frame bit budget for the next frame in the current refresh loop may be determined 240 using Equation 10:

Bᵣ^{i,j+1}=BPP+max(LIMIT_VALUE,Bᵣ^{i,j}−B_{u,I}^{i,j}−B_{u,P}^{i,j}). Equation (10)

In equations 9 and 10, the quantity LIMIT_VALUE is introduced to restrict the bit-budget for each single frame to avoid overflow of a coded picture buffer in a rate control system such as the embodiment described below in connection with FIG. 3. In either situation determined at 235, method 200 returns to 215, and continues in order to encode a following frame.

Method 200 may be adapted to handle bit rate requirements of a scene change, as described above. The selected frame may be classified as either a low texture frame or a high texture frame based on a number of bits generated in encoding the selected frame. An initial value of one or more quantization parameters for the selected frame is set to an average of quantization parameters of previous frames, in which quantization parameters of previous low texture frames are excluded from this average.

As an example criterion for classifying a frame, a frame may be classified as low texture if a number of bits generated when the frame is encoded, b(t), satisfies Equation 11:

b(t)<0.2b^{T}(t) Equation (11)

where b^{T}(t) is a target bit number. A frame not satisfying Equation 11 is classified as high texture.

FIG. 3 shows a an embodiment of a system 300 configured to reduce video latency and buffer overflow by implementing a method such as that described above and in FIG. 2. System 300 includes an encoder 320 configured to encode a received frame at input 330 and output an encoded frame to a decoder and, ultimately, to a display at output 335. System 300 also includes a refresh system 315, configured to provide a predetermined refresh pattern to encoder 320; and a rate control system 310, configured to control an encoding rate of the encoder using a method such as that described above. As will be appreciated, the display of encoded frames from output 335 may occur immediately or may occur after storage and transport of the encoded stream. As will be appreciated, frames may be transmitted from output 335 wirelessly or not wirelessly. Rate control system 310 includes a quantization parameter generator 340, configured to generate quantization parameters. Rate control system 310 also includes complexity generator 345, configured to generate complexities and supply them to quantization parameter generator 340. Inputs to complexity generator 345 may include bit rates used to transmit encoded frames. These bit rates may be provided in feedback from output of encoder 320. Inputs to complexity generator 345 also may include previous quantization parameters provided by quantization parameter generator 340. Rate control system 310 also includes a virtual buffer 350, an averager 355 for determining average target bits, and a coded picture buffer (CPB) 360. CPB 360 is connected to quantization parameter generator 340. Information on fullness of CPB 360 is conveyed to quantization parameter generator 340 and used there for the determining a magnitude of a generated quantization parameter.

System 300 may also include a scene change handling system 325. Scene change handling system 325 includes classification circuitry, configured to classify the selected frame as either low texture or high texture based on a number of bits generated in the encoding of the selected frame; and averaging circuitry configured to determine an average of quantization parameters of previous frames, such that quantization parameters of previous low texture frames are excluded from the determining of the average.

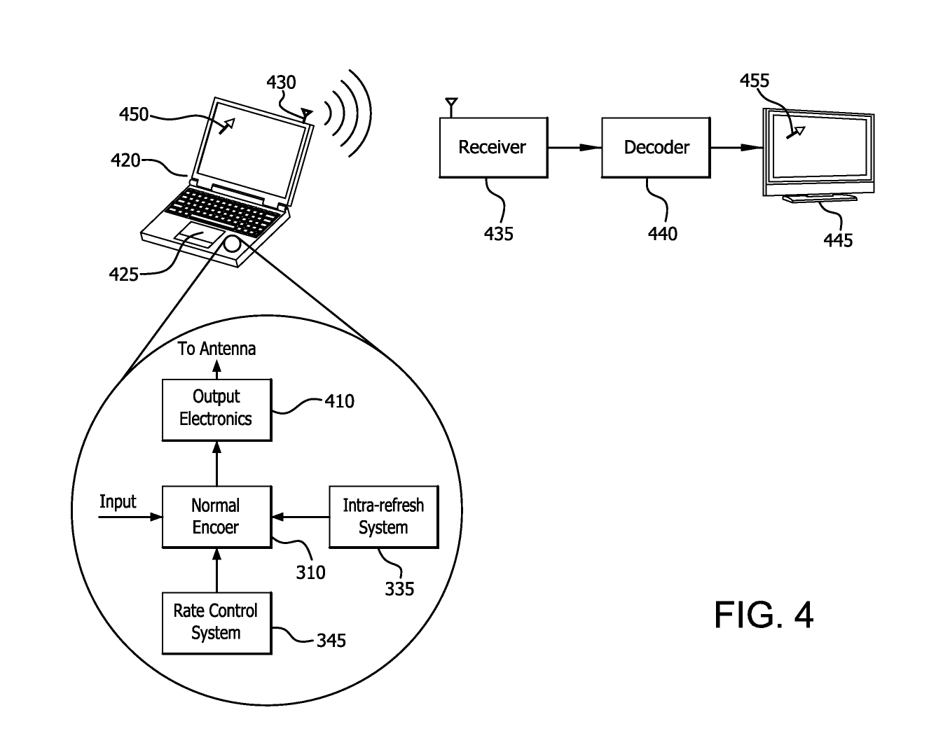

As will be appreciated by a person of ordinary skill in the art, certain embodiments disclosed herein may result in reduced latency video. One example of such embodiments is a video display system as shown in FIG. 4. A console 420, which may be a laptop computer, has a display that displays a video background (not shown) and a cursor 450 superimposed on the video background. A user moves cursor 420 manually by means of a touchpad 425 or a similarly functioning device, such as a mouse. It is desired that movement of another cursor 455 on a separate display device 445 should mimic movement of cursor 450 with no observable delay, as seen by the user. In this embodiment, console 420 contains an encoder 310, intra-refresh system 335, and rate control system 345, corresponding to identically numbered parts in FIG. 3 and described above. In accordance with the above description, encoder 310 encodes frames including video information representing cursor 450. The encoded frames are conveyed to output electronics 410 and then to an antenna 430, from which they are transmitted to receiver 435. The frames are decoded by decoder 440, which may be internal or external to receiver 435, and displayed on display device 445, the display including cursor 455. Through the use of the low-latency video compression system in console 420, including rate control system 435, movement of cursor 455 mimics movement of cursor 450 and reacts to action of the user with no delay noticeable to the user. Encoder 310, intra-refresh system 335, rate control system 335, and output electronics 410 may be implemented, separately or in any combination, through hardware, software, or a combination of hardware and software. Such hardware may include an integrated circuit, such as a graphics accelerator chip or a graphics processing chip. In FIG. 4, communication between console 420 and receiver 435 is depicted as wireless and communication between receiver 435 and display device 445 is depicted as wired. Neither of these example communications means should be construed as limiting; either one can be either wireless or wired. The system shown in FIG. 4 and described above may be included in, as examples, a video game system for the home or a video conferencing system.

Another example embodiment of low-latency video compression may be implemented as a video conferencing system, which may be one-way or two-way. Users in two or more locations transmit and receive video images. Audio may be transmitted and received as well. Reduced latency (avoiding delays) may be essential for, for example, creating a more realistic experience for users participating in a video conference.

Embodiments of the present embodiments may be represented as instructions and data stored in a non-transitory computer-readable storage medium. For example, aspects of the present embodiments may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the present embodiments.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method for reducing latency and preventing buffer overflow in video encoding, the method comprising:
dividing a selected frame from a first group of frames into P-regions and an I-region based on an assigned refresh pattern in a refresh loop;
determining an I-region bit budget and a P-region bit budget
determining quantization parameters using the I-region bit budget and the P-region bit budget;
encoding the selected frame by encoding macroblocks of the selected frame based on the quantization parameters;
updating an I-complexity and a P-complexity;
determining a new frame bit budget; and
repeating the dividing, the determining of the I-region bit budget and the P-region bit budget, the determining of quantization parameters, and the encoding for each remaining frame in the first group of frames.

2. The method of claim 1, further comprising applying the refresh loop to a second group of frames following the first group of frames, and applying the selecting, the dividing, the determining of the I-region bit budget and the P-region bit budget, the determining of the quantization parameters, the encoding, the updating, the determining of a new frame bit budget, and the repeating to the second group of frames.

3. The method of claim 1, further wherein:
the determining of an I-region bit budget comprises using current values of the I-complexity, of the P-complexity, and of the frame bit budget; and
the determining of a P-region bit budget comprises using the I-region bit budget and the current value of the frame bit budget.

4. The method of claim 3, wherein determining the P-region bit budget comprises subtracting the I-region bit budget from the current value of the frame bit budget to yield the P-region bit budget.

5. The method of claim 1, wherein determining quantization parameters further comprises using fullness of a coded picture buffer.

6. The method of claim 1, wherein
updating the I-complexity and the P-complexity comprises using an average of quantization parameters and bit quantities in the encoded selected frame; and
the updated I-complexity and the updated P-complexity are applied to a later selected frame.

7. The method of claim 1, wherein determining a new value for the frame bit budget comprises using the current value of the frame bit budget and bit quantities generated by the encoding.

8. The method of claim 1 further adapted to handle a scene change, the method further comprising:
classifying the selected frame as either low texture or high texture based on a number of bits generated in the encoding of the selected frame; and
setting an initial value of a quantization parameter for the selected frame to an average of quantization parameters of previous frames, wherein quantization parameters of previous low texture frames are excluded from the average.

9. The method of claim 1, further comprising transmitting the encoded selected frame to a display device configured to display the encoded selected frame.

10. The method of claim 9 implemented in a video display system, wherein the method further comprises transmitting the encoded selected frame to a video display device incorporated in the video display system.

11. The method of claim 10, wherein the video display system comprises at least one of: a video game system or a video conferencing system.

12. A video compression system configured to reduce latency and prevent buffer overflow; the system comprising:
an encoder configured to encode a received frame;
a refresh system, configured to provide a predetermined refresh pattern to the encoder; and
a rate control system, configured to control an encoding rate of the encoder by:
dividing a selected frame from a first group of frames into P-regions and an I-region based on the predetermined refresh pattern in a refresh loop;
determining an I-region bit budget and a P-region bit budget;
determining quantization parameters using the I-region bit budget and the P-region bit budget;
encoding the selected frame by encoding macroblocks of the selected frame based on the quantization parameters;
updating an I-complexity and a P-complexity;
determining a new frame bit budget; and
repeating the dividing, the determining of the I-region bit budget and the P-region bit budget, the determining of quantization parameters, and the encoding for each remaining frame in the first group of frames.

13. The system of claim 12, further comprising a display device configured to receive and display frames encoded by the encoder.

14. The system of claim 13, comprising at least one of: a video game system or a video conferencing system.

15. The system of claim 12, wherein the rate control system is further configured to control the encoding rate of the encoder by applying the refresh loop to a second group of frames following the first group of frames, and applying the dividing, the determining of the I-region bit budget and the P-region bit budget, the determining of the quantization parameters, the encoding, the updating, the determining of a new frame bit budget, and the repeating to the second group of frames.

16. The system of claim 12, wherein the rate control system is further configured to control the encoding rate of the encoder by:
determining the I-region bit budget using current values of the I-complexity, of the P-complexity, and of the frame bit budget; and
determining the P-region bit budget using the I-region bit budget and the current value of the frame bit budget.

17. The system of claim 16, wherein the rate control system is further configured to determine the P-region bit budget by subtracting the I-region bit budget from the current value of the frame bit budget to yield the P-region bit budget.

18. The system of claim 12 wherein the rate control system includes a coded picture buffer, the rate control system using information on the fullness of the coded picture buffer in determining the quantization parameters.

19. The system of claim 12, wherein the rate control system is further configured to control the encoding rate of the encoder by:
updating the I-complexity and the P-complexity using an average of quantization parameters and bit quantities in the encoded selected frame; and
applying the updated I-complexity and updated P-complexity to a later selected frame.

20. The system of claim 12, wherein the rate control system is further configured to control the encoding rate of the encoder by determining a new value for the frame bit budget using the current value of the frame bit budget and bit quantities generated by the encoding.

21. The system of claim 12, further comprising a scene change handling system comprising:
classification circuitry, configured to classify the selected frame as either low texture or high texture based on a number of bits generated in the encoding of the selected frame; and
averaging circuitry configured to determine an average of quantization parameters of previous frames, wherein quantization parameters of previous low texture frames are excluded from the determining of the average.

22. A non-transitory computer-readable storage medium comprising instructions and data that are acted upon by a program executable on a computer system, the program operating on the instructions and data to perform a portion of a process to fabricate an integrated circuit including circuitry described by the data, the circuitry described by the data comprising:
an encoder configured to encode a received frame;
a refresh system, configured to provide a predetermined refresh pattern to the encoder; and
a rate control system, configured to control an encoding rate of the encoder by:
dividing a selected frame from a first group of frames into P-regions and an I-region based on the predetermined refresh pattern in a refresh loop;
determining an I-region bit budget and a P-region bit budget;
determining quantization parameters using the I-region bit budget and the P-region bit budget;
encoding the selected frame by encoding macroblocks of the selected frame based on the quantization parameters;
updating an I-complexity and a P-complexity;
determining a new frame bit budget; and
repeating the dividing, the determining of the I-region bit budget and the P-region bit budget, the determining of quantization parameters, and the encoding for each remaining frame in the first group of frames.

23. The computer readable medium of claim 22, wherein the circuitry described by the data further comprises a scene change handling system comprising:
classification circuitry, configured to classify the selected frame as either low texture or high texture based on a number of bits generated in the encoding of the selected frame; and
averaging circuitry configured to determine an average of quantization parameters of previous frames, wherein quantization parameters of previous low texture frames are excluded from the determining of the average.

24. The computer readable medium of claim 22, wherein the circuitry described by the data further comprises:
the rate control system, further configured to control an encoding rate of the encoder by:
determining the I-region bit budget using current values of the I-complexity, of the P-complexity, and of the frame bit budget; and
determining the P-region bit budget using the I-region bit budget and the current value of the frame bit budget.

25. The computer readable medium of claim 22, wherein the circuitry described by the data further comprises:
the rate control system further configured to control an encoding rate of the encoder by:
updating the I-complexity and the P-complexity; and
applying the updated I-complexity and updated P-complexity to a later selected frame.
